(19) United States
(12) Patent Application Publication
(10) Pub. No.: US 2004/0230546 A1
(43) Pub. Date: Nov. 18, 2004

(54) Personalization engine for rules and knowledge

(76) Inventor: Russell A. Rogers, Bath, ME (US)

Correspondence Address: PILLSBURY WINTHROP, LLP, P.O. BOX 10500, MCLEAN, VA, 22102, US

(21) Appl. No.: 09/774,879

(22) Filed: Feb. 1, 2001

Related U.S. Application Data
(60) Provisional application No. 60/179,573, filed on Feb. 1, 2000.

(51) Int. Cl. G06N 7/08; G06N 7/00; G06F 17/00; G06N 5/02

(52) U.S. Cl. 706/47; 706/59

(57) ABSTRACT

A personalization engine for rules and knowledge includes an automatic campaign generation engine and a campaign execution engine. The automatic campaign engine detects desirable patterns of raw data, dynamically creates rule-sets, selects and applies a rule-set to an execution application, and measures an effectiveness of the applied rule-set. The campaign execution engine produces recommended results and generates an explanation for each result. The automatic campaign generation engine detects desirable pattern of raw data by determining data points that act as decision drivers and are most likely to provide desirable information. The automatic campaign generation engine measures an effectiveness of an applied rule-set by keeping track of which rules and which conditions are triggered when a rule-set is applied, and revalidating the rules against new data to ensure the rules are still accurate.

### CROSS-REFERENCE TO RELATED APPLICATION

This application claims the benefit of U.S. Provisional Application Serial No. 60/179,573, filed Feb. 1, 2000, the disclosure of which, including the specification, drawings and abstract, is incorporated herein by reference in its entirety.

### BACKGROUND OF THE INVENTION

I. Field of The Invention

The present invention relates generally to rule generation technology and, more particularly, to a personalization engine for generating rules and knowledge. The present invention allows businesses to utilize customer information to personalize communications with customers.

II. Description of Related Art

The Internet is increasingly being used as a method of communicating, advertising and shopping for and purchasing goods. Electronic commerce (e-commerce) is one of the most important aspects of the Internet. It allows people to exchange goods and services immediately and with no barriers of time or distance. Any time of the day or night, one can go online and buy almost anything one wants. At an e-commerce site, a shopper can access an electronic catalog (e-catalog) containing textual, graphical and multimedia based information about specific items. A shopper can select one or more item from an e-catalog, placing them into a virtual shopping cart. Shoppers can use search facilities provided by the e-commerce site to locate items. Once all desired items are located and selected, the shopper may proceed to a checkout process, specifying personal data (if the shopper has not previously registered) such as name, address, credit card numbers, and the like. Upon transaction completion the shopper is provided with delivery instructions or related details.

A significant problem affecting e-commerce site success is the inhibited ability to attract customers to their sites.

It is known to display an advertising banner at the upper portion of web pages to advertise products and services on the Internet. Usually, an advertising banner is randomly selected from a selection of advertisers. Although such advertising has been shown to be effective, it is very inefficient because the advertising banners may advertise particular products and services for which the viewing user would have little or no interest in purchasing. The only correlation with the interest of users is when the particular web page being viewed by a user was of interest to the user and the advertising banner was also somehow related to the content of the web page. For example, a web page of a real estate company might include advertising banners containing advertisements for mortgage companies.

Personalization mechanisms to personalize the application content of devices which electronically interact with the Internet is also known. Such personalization mechanisms include collaborative filtering. Collaborative filtering works by comparing common membership in sets. While this is a useful correlation mechanism, it is difficult to specify complex relationships with many attributes and it is hard to generate an explanation for a personalization recommendation. It also requires a significant amount of data to avoid the generation of meaningless overlapping sets.

Another personalization mechanism is neural networks. Neural networks take a set of numeric inputs through a series of transformations (i.e. weighted links) to produce a scored output. While neural networks are very good at pattern recognition, they are difficult to setup and train, and usually require significant amounts of training data. They also cannot provide an explanation of how the output was determined.

Compared to other personalization mechanisms, rule-based systems are easy to understand, especially by non-technical users. Rules can describe more complicated logical conditions without sacrificing transparency. Rule-based systems can also provide explanations of how and why a given result was derived. This helps to make the system less intimidating for both marketing managers and end-users (e.g. web site visitors).

The challenge with most rule-based systems is that significant overhead is required to generate rules. Constructing the rules requires a good understanding of the domain (i.e., what factors should be included as conditions in the rules) as well as the ability to understand the importance of rule precedence and ordering. This may require the use of a knowledge engineer to interview the subject matter expert to extract the rules. Knowledge engineering becomes an ongoing expense, making it difficult to maintain the rules once they have been created. The result is that the rules tend to be static, even if the domain knowledge is changing.

Accordingly, there is a need to address this problem.

### SUMMARY OF THE INVENTION

Therefore, one aspect of the present invention is to provide a personalization engine for generating rules and knowledge that can overcome the problems of the prior art.

A method for generating rules and knowledge according to the invention detects desirable patterns of raw data, dynamically creates rule-sets, selects and applies a rule-set, measures an effectiveness of the applied rule-set, produces recommended results, and generates an explanation for each result. The detecting step determines data points that act as decision drivers and are most likely to provide desirable information. The measuring step measures an effectiveness of an applied rule-set by keeping track of which rules and which conditions are triggered when a rule-set is applied, and revalidates the rules against new data to ensure the rules are still accurate.

A personalization engine computer program product according to the invention includes a computer usable medium having personalization engine computer readable program code embodied in said medium for generating a campaign. The personalization program code includes computer readable automatic campaign generation engine program code and campaign execution engine codes. The automatic campaign engine program code detects desirable patterns of raw data, dynamically creates rule-sets, selects and applies a rule-set to an execution application, and measures an effectiveness of the applied rule-set. The computer readable campaign execution engine program code produces recommended results and generates an explanation for each result. The automatic campaign generation engine program code detects desirable pattern of raw data by determining data points that act as decision drivers and are most likely to provide desirable information. The automatic campaign generation engine program code measures an effectiveness of an applied rule-set by keeping track of which rules and which conditions are triggered when a rule-set is applied, and revalidating the rules against new data to ensure the rules are still accurate.

A system including a processor and memory for generating rules and knowledge according to the invention comprises personalization engine program code for generating a campaign. The campaign generation engine program code detects desirable patterns of raw data, dynamically creates rule-sets, selects and applies a rule-set to an execution application, and to measure an effectiveness of the applied rule-set. The campaign execution engine program code produces recommended results and generates an explanation for each result. The automatic campaign generation engine program code detects desirable pattern of raw data by determining data points that act as decision drivers and are most likely to provide desirable information. The automatic campaign generation engine program code measures an effectiveness of an applied rule-set by keeping track of which rules and which conditions are triggered when a rule-set is applied, and revalidating the rules against new data to ensure the rules are still accurate.

These and other aspects of the present invention will be described in or readily apparent upon further review of the following specification and drawings.

### BRIEF DESCRIPTION OF THE DRAWINGS

Preferred embodiments of the invention will be described in relation to the appended drawings, in which:

FIG. 1 is a block diagram of a computer system equipped with the personalized engine according to the present invention;

FIG. 2 is a block diagram of the Internet with a plurality of client devices and a server equipped with the personalized engine according to the present invention;

FIG. 3 is a flow chart of the automatic campaign generation engine according to the present invention; and

FIG. 4 is a flow chart of the campaign execution engine according to the present invention.

Similar reference characters denote corresponding features consistently throughout the attached drawings.

### DETAILED DESCRIPTION OF PREFERRED EMBODIMENTS

The present invention is a personalization engine for generating rules and knowledge. The personalization engine automatically creates first-order predicate logic rules.

The personalization engine carries out a form of supervised learning. The personalization engine analyzes the attributes of a number of sample cases where the classification is already known. It determines which attribute contributes the most to determining the correct classification of each case. This is achieved by comparing the information contained in the classification itself (best case) to the information about the classification contained in the attribute (actual). This process is repeated on each data subset until the point is reached where additional attributes do not contribute to the accuracy of the classification. The result is a highly accurate decision tree. While the tree is very accurate, it can be very bushy and hard to understand. The personalization engine converts the decision tree into a campaign (i.e. set of rules).

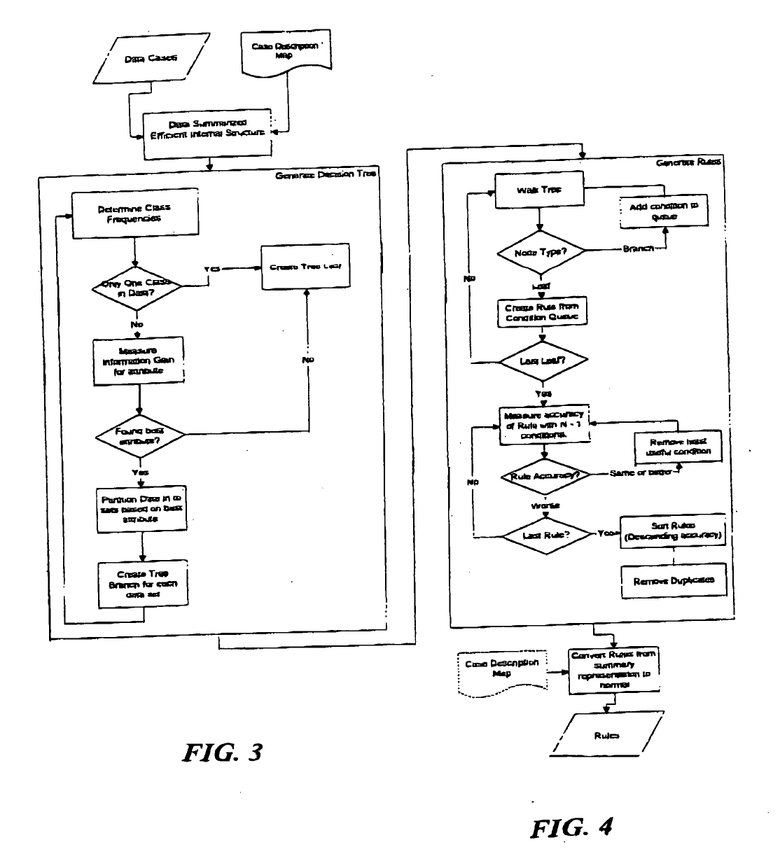

Initially, each rule represents one branch of the tree from root to leaf. The personalization engine then evaluates these rules against a data sample to determine their predictive accuracy. If any rule condition does not contribute to the accuracy of the rule, it is discarded. Next, the rules are ordered to maximize the accuracy of the complete rule set. A flow chart of this process is shown in FIG. 3.

After the rules are generated they may be stored in XML (extensible markup language), allowing for easy integration with other applications.

The personalization engine provides a mechanism for revalidating the rules against new data to improve their accuracy and provides detailed reporting of rule accuracy, flagging an inaccurate campaign. A flow chart of this process is shown in FIG. 4.

During campaign execution, the personalization engine automatically generates an explanation by recording which rule conditions match the current inputs.

The personalization engine determines which attributes to use in the rule set. The personalization engine functions in a similar manner to a lossy compression algorithm. In the same way that a compression algorithm takes some piece of data and turns it into a smaller representation, the personalization engine takes a number of cases and turns them into a set of rules that are a compressed representation of the source data. Consider a set of barnyard animals. Each animal could be described by a number attributes such as color, height, weight, tail type (long, short, curly, bushy), food, etc. It is desirable to compress the knowledge of barnyard animals into the smallest possible representation so that when a new animal arrives, it can be classified correctly. Like compression, it is desirable to distill the essence of the animal down into the smallest possible number of attributes. Assume that only one attribute may be used (the smallest possible compression). It is desirable to select the attribute that gives the best indication of the animal. This may result in some misclassifications, as it is a lossy algorithm. If the process is repeated, by adding attributes, the compression algorithm becomes more accurate but with a larger representation (i.e. less compression, less loss).

The presentation engine provides some settings that control the amount of compression (i.e. increase or decrease the acceptable error rate) and the interpretation of unknown values during rule execution.

The personalization engine does not use a statistical measure of correlation to select attributes. The personalization engine measures the difference between compressing the data based on the class versus compressing the data based on some attribute. An attribute is selected that gives the best compression. The data is partitioned based on this attribute and then the process is repeated, by selecting a different attribute. Unlike statistical measures, this does not require significant data volume.

Similar to a compression algorithm, the personalization engine can use the campaign rules to compress some new data with known cases and measure the accuracy of the process (i.e. is the data still recognizable after compression). This can be done using a reserved data sample or by passing the original data back through the rules and using pessimistic error estimation to determine the accuracy of the rules. Therefore, the personalization engine generates good rules.

There are several key advantages of the inventive personalization engine technology. (1) Rules are easy to understand. There are no complicated statistical weights or abstract concepts. People can intuitively understand the campaign. (2) The personalization engine does not require a large amount of data, unlike statistical measures that require enough data to test for significance. This allows for frequent regeneration of the rules, ensuring that the rules are accurate, not static or stale. (3) The personalization engine can use a variety of attribute data sources such as click stream, explicit user data (accounts, surveys, etc), or legacy/offline systems such as CRM and ERP systems. The data does not need to be all numeric. (4) Because the rules are easy to understand, marketing managers can also customize them. This allows for a very precise fine-tuning of the system by combining the personalization engine analysis with the specialized domain experience of marketing managers.

The presentation engine invention may be run on a variety of computers or collection of computers under a number of different operating systems. The computer could be, for example, a hand held computer, a personal computer, a mini computer, mainframe computer or a computer running in a distributed network of other computers. In fact the invention assumes that a variety of client devices running a variety of browsers is in use in the Internet or intranet.

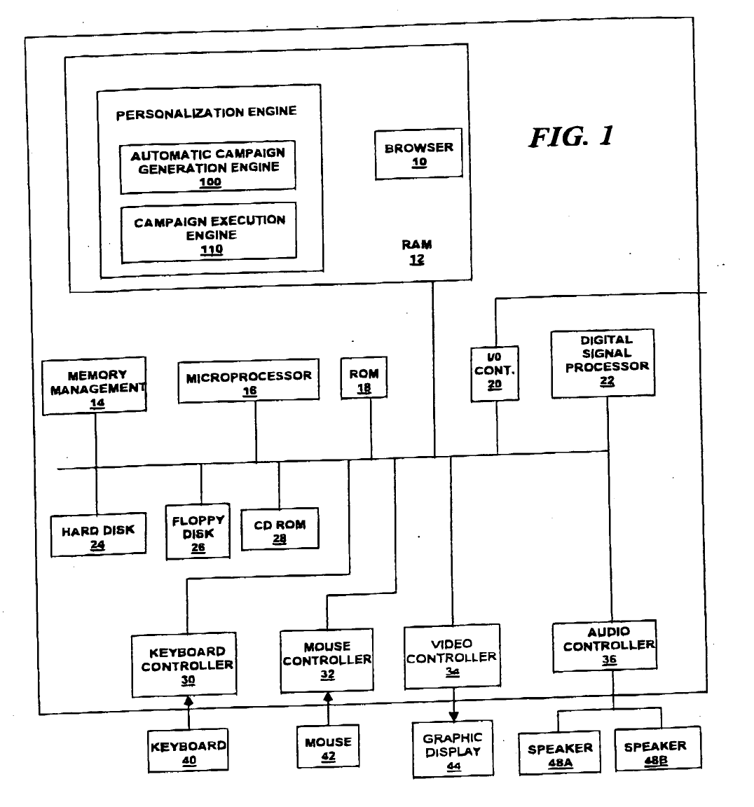

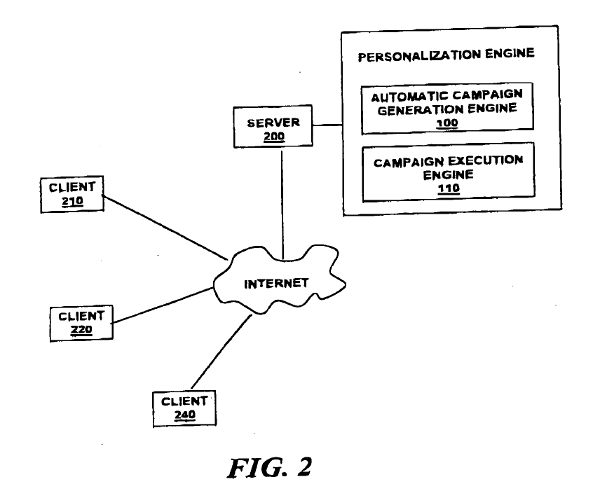

In FIG. 1, a computer, comprising a system unit, a keyboard, a mouse and a display are depicted in block diagram form. The system unit includes a system bus or plurality of system buses to which various components are coupled and by which communication between the various components is accomplished. The microprocessor is connected to the system bus and is supported by read only memory (ROM) and random access memory (RAM) also connected to system bus.

The ROM contains among other code the Basic Input-Output system (BIOS) which controls basic hardware operations such as the interaction of the processor and the disk drives and the keyboard. The RAM is the main memory into which the operating system and application programs are loaded. The memory management chip is connected to the system bus and controls direct memory access operations including, passing data between the RAM and hard disk drive and floppy disk drive. The CD ROM 32 also coupled to the system bus is used to store a large amount of data, e.g., a multimedia program or presentation.

Also connected to this system bus are various I/O controllers: the keyboard controller, the mouse controller, the video controller, and the audio controller. As might be expected, the keyboard controller provides the hardware interface for the keyboard, the mouse controller provides the hardware interface for mouse, the video controller is the hardware interface for the display, and the audio controller is the hardware interface for the speakers. An I/O controller enables communication over a network to other similarly configured data processing systems.

Depending on the client device, there will be differences in the capabilities of the display, memory and processor. In addition, some devices, notably handheld devices, may lack some of the elements discussed above such as a keyboard and mouse, substituting them with a touch screen and stylus. These devices generally communicate with the network using a wireless transmission means in the RF or IR spectrums. Set top boxes such as WebTV may lack the keyboard and mouse, substituting a handheld remote of limited capability. The use of a conventional television instead of a computer monitor also means that the display will lack the resolution and addressable screen size assumed by the developers of user interfaces for computer interfaces. The present invention allows a customized user interface for these and other client devices.

The personalization engine includes sets of instructions resident in a computer readable medium, such as the random access memory of one or more computer systems configured generally as described above. Execution of the sequences of instructions causes the processor to perform process steps. In alternative embodiments, hard-wired circuitry may be used in place of or in combination with software instructions to implement the invention. Until required by the computer system, the set of instructions may be stored in another computer readable medium, for example, in the hard disk drive, or in a removable computer readable medium such as an optical disk for eventual use in the CD-ROM or in a floppy disk for eventual use in the floppy disk drive. The computer readable medium is not limited to these devices, and may include a flexible disk, magnetic tape, or any other magnetic medium, any other optical medium, punch cards, paper tape, any other physical medium with patterns of holes, a PROM, an EPROM, a FLASH-EPROM, any other memory chip or cartridge, a carrier wave embodied in an electrical, electromagnetic, infrared, or optical signal, or any other medium from which a computer can read.

Further, the set of instructions can be stored in the memory of another computer and transmitted in a computer readable medium over a local area network or a wide area network such as the Internet when desired by the user. One skilled in the art would appreciate that the physical storage of the sets of instructions physically changes the medium upon which it is stored electrically, magnetically, or chemically so that the medium carries computer readable information. While it is convenient to describe the invention in terms of instructions, symbols, characters, or the like, the reader should remember that all of these and similar terms should be associated with the appropriate physical elements.

Thus, embodiments of the invention are not limited to any specific combination of hardware circuitry and software.

Further, the invention is often described in terms that could be associated with a human operator. While the operations performed may be in response to user input, no action by a human operator is desirable in any of the operations described herein which form part of the present invention; the operations are machine operations processing electrical signals to generate other electrical signals.

The personalization engine automatically computes weighted values for unknown attribute values to handle missing data values unlike cross tabulation methods that must discard cases with missing values.

The personalization engine may additionally include a workflow system that is dynamically configurable using a graphical tool, to allow a sales or marketing manager to further enhance a customer's experience by easily defining how the customer is managed. Examples of workflow actions include determining what additional information should be offered or collected, automatically connecting the customer to an on-line chat session, initiating a web-push, or other relevant actions.

The business manager is able to define or tweak the life cycle of a customer interaction by modifying campaigns to react to custom events and actions that are customer or system generated. The workflow system can respond to external events, including web-based activity, as well as Site Server generated events. The workflow sub-module leverages the personalization engine modules. Users can create custom actions using various scripting languages and tools, allowing for maximum power and flexibility.

The personalization engine may also include a Hot Campaign submodule. The Hot Campaign submodule offers content that changes dynamically, based on user usage. The most frequent navigation sets gain higher prominence on the web site, and an individual user will experience content that is geared towards issues of interest that are specific and personalized.

The personalization engine may also include a Survey submodule. The Survey submodule provides customizable forms that allow the user to express their views and track responses via reports and feedback. Surveys can be automatically tallied and tracked, and marketing campaigns can be driven off of the survey results. The Survey module may also be tied to the Workflow submodule, providing for specialized tracking and notification services.

The personalization engine may also include a Customer Personalization Manager submodule. The Customer Personalization Manager submodule logs, tracks, and manages customer interactions. In addition, the Customer Personalization Manager submodule provides access to the systems core services, such as workflow, business rules, security and permissions, and other custom system actions. The Customer Personalization Manager submodule insures that customer interactions are properly prioritized and presented in the appropriate manner.

The personalization engine may also include a Reporting Tools submodule. The Reporting Tools submodule provides extensive out-of-the box reporting capabilities. Pre-formatted reports are available to a sales or marketing manager. These reports can be used “as is”, or they can easily be modified with a “point and click” report generator. Ad hoc queries and query by example search capabilities are also provided in a simple and easy to use interface.

The personalization engine may also include an E-Mail Integrator submodule. The E-Mail Integrator submodule integrates with various email environments. The E-Mail Integrator submodule can automatically format, generate and send individual and bulk emails. The E-Mail Integrator submodule can also automatically send updates to the customer as the status of an issue changes or upon any other predetermined event in the customer interaction life cycle.

Additional submodules which may be included with the personalization engine include a Customer Chat submodule, an Intelligent Web push submodule, an Instant Messaging submodule, a Voice over IP submodule, and a Telephony Integration Submodule. The Customer Chat submodule automatically establishes a session between a salesperson and a high value customer, and allows a salesperson to handle multiple customer sessions simultaneously. The Intelligent Web push submodule provides marketing, service updates, special offers, and instant messaging capabilities. The Instant Messaging submodule allows customers to drop a note to the sales or marketing department. The Voice over IP submodule allows high value customers to establish a voice session with the sales department from a button on the e-commerce website thereby providing in-context conversion. The Telephony Integration Submodule provides call in/out ability, and provides screen pop with customer information.

The following outlines the personal engine elements required for the present invention. The personalization engine includes (1) an automatic campaign generation engine to perform detection, creation, application, and measurement; and (2) a campaign execution engine to produce recommended results based on a campaign rule-set and click-stream data.

A method for generating rules and knowledge according to the invention detects desirable patterns of raw data, dynamically creates rule-sets, selects and applies a rule-set, measures an effectiveness of the applied rule-set, produces recommended results, and generates an explanation for each result. The detecting step determines data points that act as decision drivers and are most likely to provide desirable information. The measuring step measures an effectiveness of an applied rule-set by keeping track of which rules and which conditions are triggered when a rule-set is applied, and revalidates the rules against new data to ensure the rules are still accurate.

A personalization engine computer program product according to the invention includes a computer usable medium having personalization engine computer readable program code embodied in the medium for generating a campaign. The personalization program code includes automatic campaign generation engine program code and campaign execution engine codes. The automatic campaign engine program code detects desirable patterns of raw data, dynamically creates rule-sets, selects and applies a rule-set to an execution application, and measures an effectiveness of the applied rule-set. The campaign execution engine program code produces recommended results and generates an explanation for each result. The automatic campaign generation engine program code detects desirable pattern of raw data by determining data points that act as decision drivers and are most likely to provide desirable information. The automatic campaign generation engine program code measures an effectiveness of an applied rule-set by keeping track of which rules and which conditions are triggered when a rule-set is applied, and revalidating the rules against new data to ensure the rules are still accurate.

A system including a processor and memory for generating rules and knowledge according to the invention comprises personalization engine program code for generating a campaign. The personalization engine program code includes automatic campaign generation engine program code and campaign execution engine codes. The automatic campaign engine program code detects desirable patterns of raw data, dynamically creates rule-sets, selects and applies a rule-set to an execution application, and to measure an effectiveness of the applied rule-set. The campaign execution engine program code produces recommended results and generates an explanation for each result. The automatic campaign generation engine program code detects desirable pattern of raw data by determining data points that act as decision drivers and are most likely to provide desirable information. The automatic campaign generation engine program code measures an effectiveness of an applied rule-set by keeping track of which rules and which conditions are triggered when a rule-set is applied, and revalidating the rules against new data to ensure the rules are still accurate.

The personalization engine customizes information provided from a content server to a user of a computer system through a network in accordance with attributes such as demographic classifications, user interests, preferences, or other demographic information. Such customizing can involve banner advertising on the Internet whereby the advertising banners are able to be targeted to the user. The customizing can also involve altering portions of a web page to be displayed to the user so that the web page is more effective, useful or desirable for the user.

Demographic information broadly encompasses a wide range of information pertaining to a user. More particularly, demographic information can pertain to demographic categories, user interests, preferences (user or system), hobbies, user's preferred greeting name, and the like. User preferences can include a wide range of items such as preferences for Internet page formats and resolution, types, language, dislikes, likes, customization desired, etc.

The data utilized by the invention is obtained using a variety of techniques which form no part of the invention. Typically, this type of data is stored in publicly accessible data warehouses.

It is to be understood that the present invention is not limited to the preferred embodiments, which are illustrative. Various modifications will occur to those of ordinary skill in the art which are within the scope of the present invention.

What is claimed is:

1. A method for generating rules and knowledge, comprising:
detecting desirable patterns of raw data;
dynamically creating rule-sets
selecting and applying a rule-set;
measuring an effectiveness of the applied rule-set; and
producing recommended results.

2. The method for generating rules and knowledge according to claim 1, further comprising generating an explanation for each result.

3. The method for generating rules and knowledge according to claim 1, wherein said detecting step determines data points that act as decision drivers and are most likely to provide desirable information.

4. The method for generating rules and knowledge according to claim 1, wherein said measuring step measures an effectiveness of an applied rule-set by keeping track of which rules and which conditions are triggered when a rule-set is applied, and revalidates the rules against new data to ensure the rules are still accurate.

5. A personalization engine computer program product for rules and knowledge, comprising:
a computer usable medium having personalization engine computer readable program code embodied in said medium for generating a campaign;
computer readable automatic campaign generation engine program code embodied in said medium, to detect desirable patterns of raw data; to dynamically create rule-sets; to select and apply a rule-set to an execution application; to measure an effectiveness of the applied rule-set;
computer readable campaign execution engine program code embodied in said medium, to produce recommended results; and to generate an explanation for each result.

6. A personalization engine computer program product according to claim 5, wherein said automatic campaign generation engine program code detects desirable pattern of raw data by determining data points that act as decision drivers and are most likely to provide desirable information.

7. A personalization engine computer program product according to claim 5, wherein said automatic campaign generation engine program code measures an effectiveness of an applied rule-set by keeping track of which rules and which conditions are triggered when a rule-set is applied, and revalidating the rules against new data to ensure the rules are still accurate.

8. A system including a processor and memory for generating rules and knowledge, comprising:
personalization engine program code for generating a campaign;
campaign generation engine program code to detect desirable patterns of raw data; to dynamically create rule-sets; to select and apply a rule-set to an execution application; and to measure an effectiveness of the applied rule-set;
campaign execution engine program code to produce recommended results, and to generate an explanation for each result.

9. A system according to claim 8, wherein said automatic campaign generation engine program code detects desirable pattern of raw data by determining data points that act as decision drivers and are most likely to provide desirable information.

10. A system according to claim 8, wherein said automatic campaign generation engine program code measures an effectiveness of an applied rule-set by keeping track of which rules and which conditions are triggered when a rule-set is applied, and revalidating the rules against new data to ensure the rules are still accurate.
